(19) United States
(12) Patent Application Publication
(10) Pub. No.: US 2017/0076369 A1
(43) Pub. Date: Mar. 16, 2017

(54) System And Method For Performing Due Diligence And Providing A Report For A Potential Real Estate Transaction

(71) Applicant: First Lenders Data, L.P., Austin, TX (US)

(72) Inventors: Tedd R. Smith, Austin, TX (US); Corey R. Smith, Austin, TX (US); Charles F. Bloodgood, Austin, TX (US); Timothy R. Smith, Austin, TX (US)

(21) Appl. No.: 15/260,543

(22) Filed: Sep. 9, 2016

Related U.S. Application Data
(60) Provisional application No. 62/216,508, filed on Sep. 10, 2015.

(51) Int. Cl. G06Q 40/02

(52) U.S. Cl. CPC G06Q 40/025; G06Q 50/16

(57) ABSTRACT

A system and method for performing due diligence for a potential real estate transaction is provided. An Intelligence Engine is used to access a customer profile to order and create an Intelligence Engine object for each transaction using specific rules processor and action library. The Intelligence Engine obtains pertinent information from multiple information vendors and assembles a customer Report based on the customer profile and order.

### RELATED APPLICATIONS

This application claims priority to the following Provisional application: U.S. Provisional Patent Application Ser. No. 62/216,508, filed Sep. 10, 2015, and entitled “SYSTEM AND METHOD FOR PERFORMING DUE DILIGENCE AND PROVIDING A REPORT FOR A POTENTIAL REAL ESTATE TRANSACTION,” which is hereby incorporated by reference in its entirety.

### BACKGROUND OF THE INVENTION

1. Field of the Invention

The present invention relates generally to a system and method for performing due diligence for a potential real estate transaction and in particular, to an Intelligence Engine that uses customer orders and profiles to execute rules and actions for obtaining information from multiple vendors.

2. Description of the Related Art

In the late 1990's and early 2000's, several companies attempted to offer instant and insured title searches and property reports, but attempts to provide comprehensive flood, valuation, and insured property reports in an instantaneous fashion have been unsuccessful. Some companies offered credit bases lien reports while others tried to offer automated legal and vesting reports, but almost all fell short of servicing what the lenders truly needed. Some companies tried to automate full owners and encumbrance reports, but the instant versions of all of these reports failed as well.

From a valuation perspective, many lenders for real estate transactions used to rely on automated valuation models (AVMs) to determine the value on their borrower's property for home equity or second mortgage lending, but on Dec. 10, 2010, five federal banking agencies, the OCC, FRB, FDIC, OTS and NCUA, issued their revision to the Interagency Appraisal and Evaluation Guidelines. The revised guidelines became effective immediately and one of the most important aspects was that AVMs and Tax Assessed Values (TAVs) could no longer be used on home equity and second mortgages without a property condition Report and AVM validation and/or back-testing. As such, most lenders stopped using automated valuations and instead started using 2055 drive-by or other valuations at a much higher expense with longer turn times.

Many challenges exist in obtaining due diligence information for real estate transactions, such as:

Industry Challenge #1—Instant legal and vesting information is not always recordable. When companies seek to record the transaction, the information is incorrect, which causes delays, corrections, and insurance coverage gaps. As a result, lenders stopped using these instant versions and insurance companies discontinued their coverage programs.

Industry Challenge #2—Instant data on current mortgages and personal liens do not match up at the borrower and property level. As a result, lenders have too many claims and insurance companies discontinued their programs.

Industry Challenge #3—Some companies try to insure just the legal and vesting information without providing transaction history, liens, judgments and other encumbrances in a standard property Report or limited title search. Other companies try to insure nothing and offer a borrower affidavit for the borrower to sign and attest to the fact that there are no other liens, judgments or encumbrances known to them that were not already known to the lender. The problem with this service is that the borrower often doesn't know what the lender knew or didn't know and the borrower simply signed in good faith. Most insurance companies dropped this program with the exception of one off-shore agency with less than an A rating.

Industry Challenge #4—Many lenders obtain false information that they could no longer use automated valuation models or other automated means to determine the value of properties on home equity loans and second mortgages. Contrary to some interpretations, the utilization of automated valuations is not forbidden by the OCC, NCUA, or other regulatory bodies, but many companies stayed away from them due to the requirement, time, and expense associated with validating and back-testing the automated valuation models.

### SUMMARY OF THE INVENTION

The challenges outlined above are addressed by various aspects of the system and method described herein. In a broad form one embodiment of the present invention is a method for generating a Report to a customer relating to a potential real estate transaction. The method builds a customer profile indicative of Report configuration and saves the profile to a database. An XML rule format associated with the customer profile is built and saved to a database. Upon receiving a request for a Report from a customer the associated XML rules format from the database is accessed and an Intelligence Engine is requested to process the request, including using the customer profile and request to perform actions to obtain information from a number of information vendors. The method then generates a customer file associated with the request in a database and receives information from vendors in the customer file before populating the customer file with the information returned from the separate information vendors. Finally, a Report is assembled using the information populated in the customer file in the database based at least in part on said customer profile.

In another form, the present invention addresses an Intelligence Engine configured and operated to perform due diligence for a real estate transaction. The method accesses a customer profile and creates an XML rule format based on the customer profile prior to saving the XML rule format to a database. An Intelligence Engine is operated having rule processors created based on said customer profile and having an actions library based on said customer profile to receive a customer order and use the customer order to access the XML rule format from the database and generating a request to the Intelligence Engine. The Intelligence Engine executes at runtime after the request to identify the desired actions, including generating information requests sent to multiple information vendors. Preferably, upon receipt of a customer order, the Intelligence Engine uses the customer profile to create a unique run time object for each customer order.

In another form, the Intelligence Engine hereof is created using a customer profile, which includes customer preferences, preferred data sources and report configuration preferences. An Intelligence Engine Object (IEO) is instantiated using the customer profile and a customer request for a particular real estate transaction. During development time, the IEO send requests to the preferred data sources and stores information received from the data sources in a database. During run time, the IEO accesses the received data in the database and generates a report based at least in part on the report configuration preferences.

### DESCRIPTION OF THE DRAWINGS

FIG. 1 is a high level diagram of the flow of a typical transaction;

FIG. 2 is a depiction of the Automation Model showing how the Report is assembled;

FIG. 3 illustrates the Data Model used in assembling the Report;

FIG. 4 is a flow diagram of the typical transaction for the consumer (B2C) and business (B2B);

FIG. 5 is a graphic describing the Intelligence Engine at a high level;

FIG. 6 is a flow diagram illustrating the communications of the Intelligence Engine;

FIG. 7 is a flow diagram describing how the Intelligence Engine processes orders from a customer;

FIG. 8 is a flow diagram illustrating the logic used in the Intelligence Engine;

FIG. 9 is a flow diagram showing the UDV Processing;

FIG. 10 is flow diagram showing a comparison of borrower credit data with property mortgages;

FIG. 11A is a graphic of the source code for a sample load method;

FIG. 11B is a graphic of a description of profile data;

FIG. 11C is a graphic showing a description of “Configuration”;

FIG. 12A is a graphic showing the logic call for order processing;

FIG. 12B is a graphic of code for an order processing example;

FIG. 13A is a graphic of code for logic rules during order processing;

FIG. 13B is a graphic of code for logic rules during order processing;

FIG. 13C is a graphic of code for customizable logic rules;

FIG. 14 is a graphic of code for “return value” routine; and

FIG. 15 is a table showing the attributes of an “intelligence engine object.”

### DETAILED DESCRIPTION OF THE PREFERRED EMBODIMENTS

Different embodiments of the present invention are used to perform due diligence on a potential real estate transaction and provide the customer with a Report. Different customers require or desire different data for a Report and, accordingly, create a unique profile specific to the customer. Each customer profile will specify the data desired from a number of information vendors.

A deed is one example of data obtained for use in a Report. A copy of the deed is always provided with a Report generated using the system and methods described herein. If the instant legal and vesting information is abbreviated or incorrect, the full legal description and accurate vesting information is always found on the deed. If a customer does not want to rely on the copy of the deed and/or rekey data into their LOS or doc prep system, the customer can choose to have a fully recordable legal and vesting Report included in the Report. The full legal description and vesting information included in text format is not instantaneous, but the Report will automatically update itself with this optional “add-on” service within 5-25 minutes in most cases or within 24 hours if additional time is required.

By tapping multiple data sources, title plants, and a myriad of other resources, the present system and method instantly provides accurate and reliable liens, judgments, and current mortgages at the borrower and property level.

The Report provides the full legal description along with the full transaction history, personal liens, judgments, and other encumbrances. As such, the insurance company utilized is a reputable on shore carrier with A+ rated credentials.

The present system and method offers a comprehensive, yet inexpensive means to validate and back-test the instant values obtained in the Report.

The Report is automatically configured based on a proprietary “intelligence engine” and a user profile stored in a database. The user profile is entered into a database via an interview process with the customer. The profile contains limits, setpoints, and ranges consisting of numerical or alphanumerical values and keywords. These values and keywords are used by an “intelligence engine” that captures industry knowledge. This “intelligence engine” uses industry knowledge and the user profile to make decisions. These decisions are used to automatically configure the values and sections that are displayed in the Report. For example, the Report could show the loan disapproval section if the Intelligence Engine determines that the loan to value (LTV) is calculated to be above a customer specified setpoint of 50%.

The data used for the Report is automatically acquired by the “intelligence engine” using the customer profile stored in a database and the customer request. The user profile is analyzed to determine preferred sources for some of the data. The profiles include keywords to identify certain information that is unique and informative to the intelligence engine. The “intelligence engine” contains industry knowledge about sources of information. The keywords are used by the “intelligence engine” to make choices about the data sources. Communications to the data sources are automatically sent out in sequence or in parallel under the direction of the “intelligence engine.”

As third party data sources respond to these information requests, the Intelligence Engine organizes and stores this information for use. Depending on the responses from the third party data sources, the Intelligence Engine automatically uses proprietary industry knowledge to determine if additional data is required, and if so, which third party data sources should be solicited. For example, if the first AVM vendor does not have a record of the property, the Intelligence Engine will automatically request the information from a second vendor

The Report is automatically assembled piecemeal as the proprietary “intelligence engine” gathers information from multiple sources. The default structure of the Report is stored in the database. Additional optional or alternative Report sections are also stored in the database. As the “intelligence engine” gathers information from multiple sources, it loads the various data elements it receives into a database. Using industry knowledge, the “intelligence engine” examines those data values to automatically make decisions about Report structure. The different elements of the Report are automatically brought together as determined by the Intelligence Engine and stitched together into a unified Report. For example, if the response from the third party vendor shows that the borrower has a personal lien, then the Intelligence Engine automatically recognizes that fact and includes a record of that in the output Report.

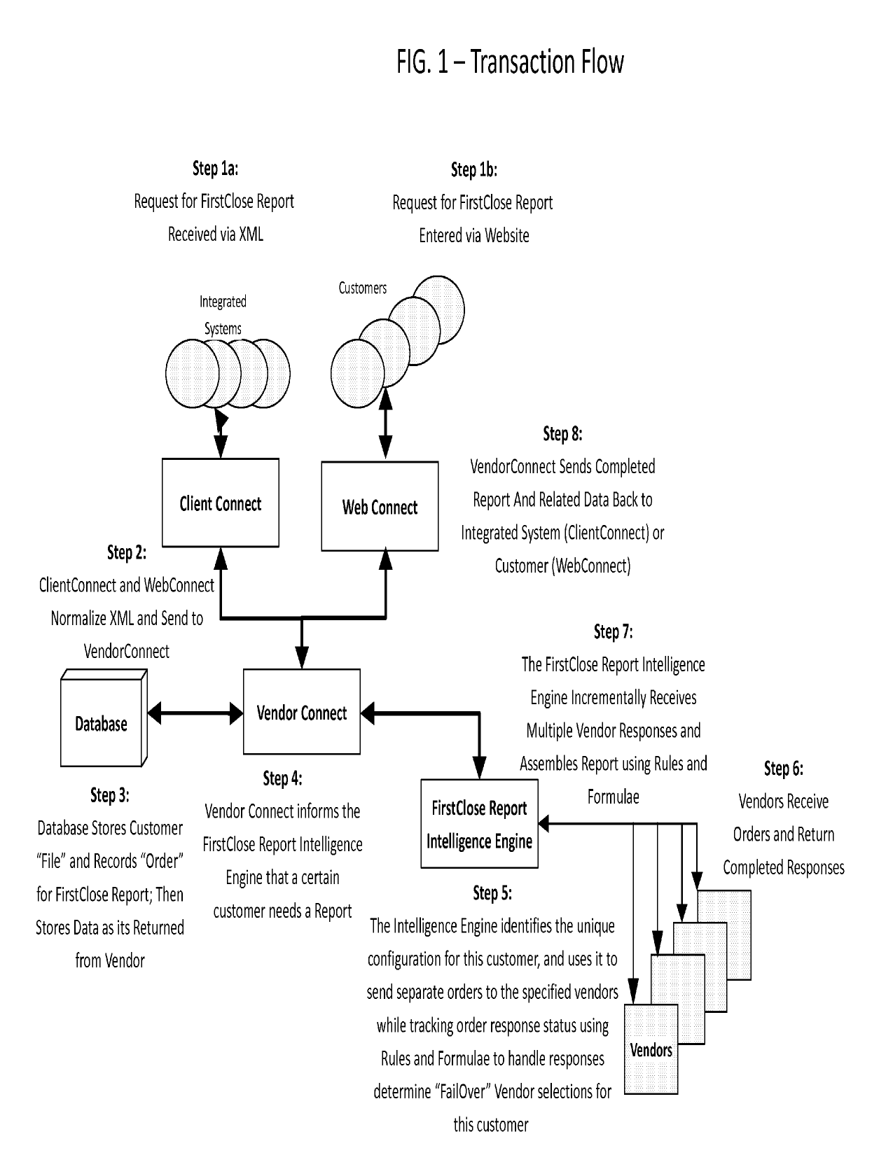

Turning to the drawings, FIG. 1 illustrates the Transaction Flow for a Report. The Report is generated by a combination of several subsystems. These include ClientConnect and WebConnect which interface with the customer, VendorConnect which handles communications with the vendors, and an Intelligence Engine which guides the processing of the vendor requests and the creation of the Report. As can be seen, the system accepts a “request” or customer order either through the web (step 1b) or via email (step 1a). In either event, the request is normalized (step 2) and sent to the “vendor connect” seen at step 4. The “vendor connect” functionality has previously stored in the database a unique profile for each customer. The request and customer profile are sent to the “Intelligence Engine” (step 5) which generates information requests with various vendors (step 6). As the data is returned from the vendors, it is stored in the Database. Once the Intelligence Engine determines it has received all of the requested information, a Report is assembled and sent to the customer (steps 7, 8).

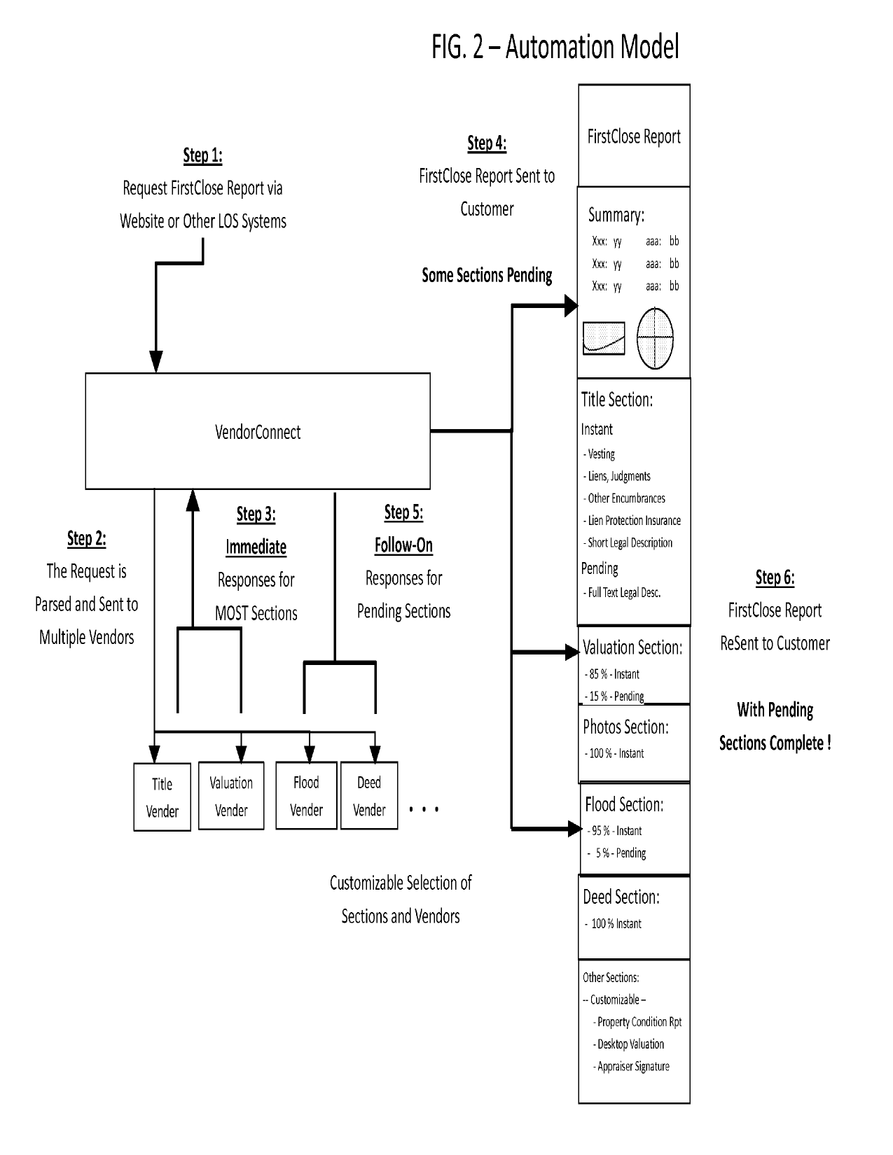

FIG. 2 is a depiction of the Automation Model. FIG. 2 shows how the Report is assembled as automatic communications are sent to vendors and responses are received. In particular, VendorConnect, based on guidance from the Intelligence Engine, parses and sends the data requests to a number of vendors. As seen in FIG. 2, the process is iterative until all of the data is received (steps 2-5). Steps 4 and 6 show the sections of the Report.

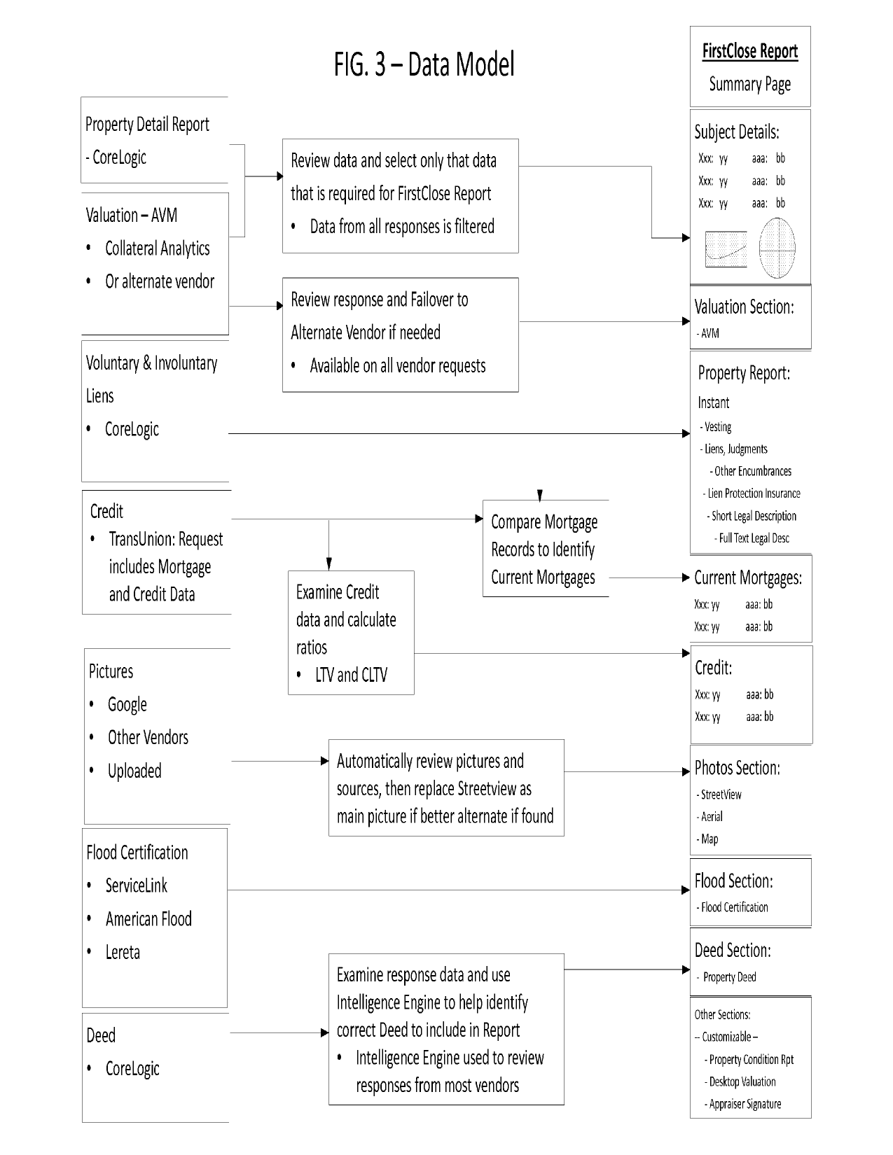

FIG. 3 illustrates the Data Model used in assembling the Report. FIG. 3 expands on FIG. 2 by showing how specific vendors populate different sections of the Report. Each section of the Report receives data from one or more different vendor products.

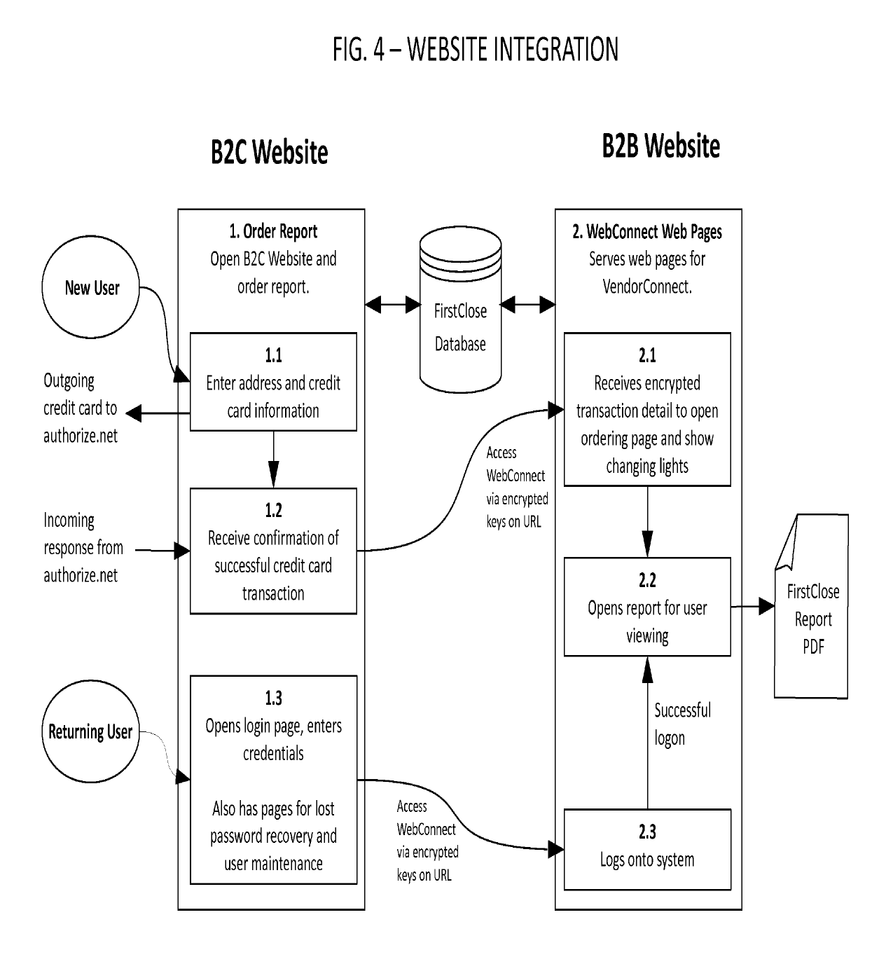

FIG. 4 is a flow diagram of a website showing use by customers (B2C) and vendors (B2B). As shown in FIG. 4, a new or returning user orders a Report, making payment or login as required. The B2B web pages interface with the database to obtain the vendor data and populate the Report as it is assembled. The user can view the Report at most stages of development.

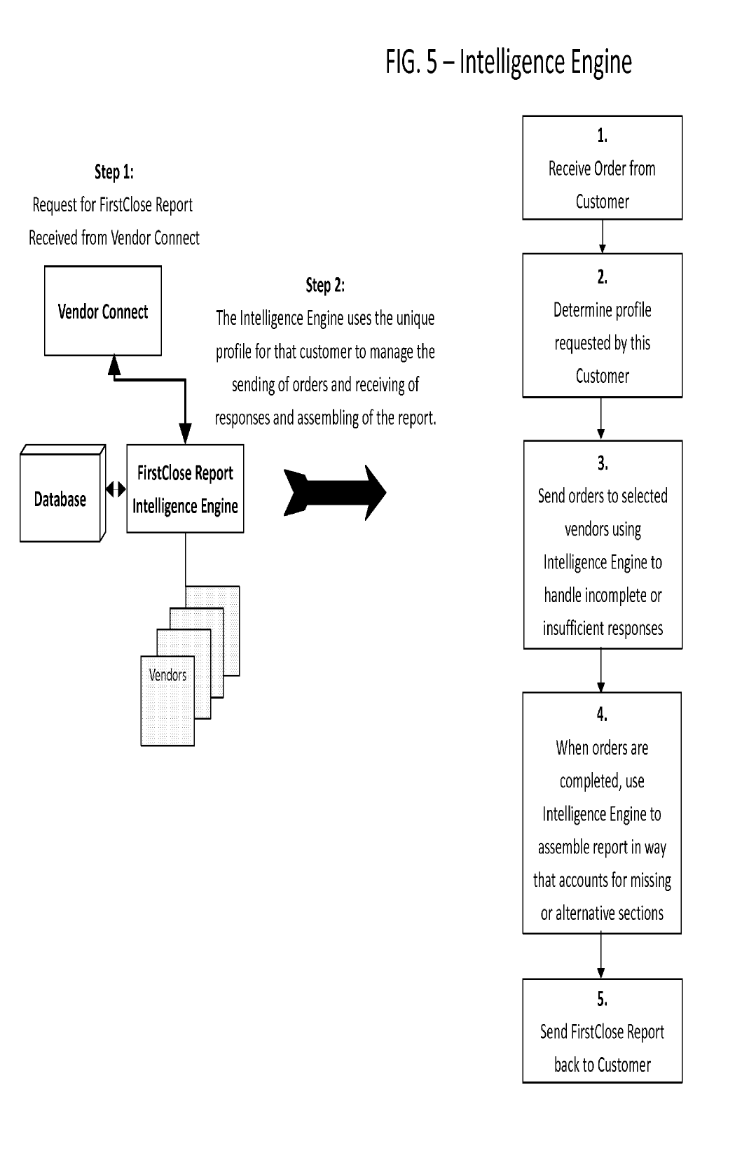

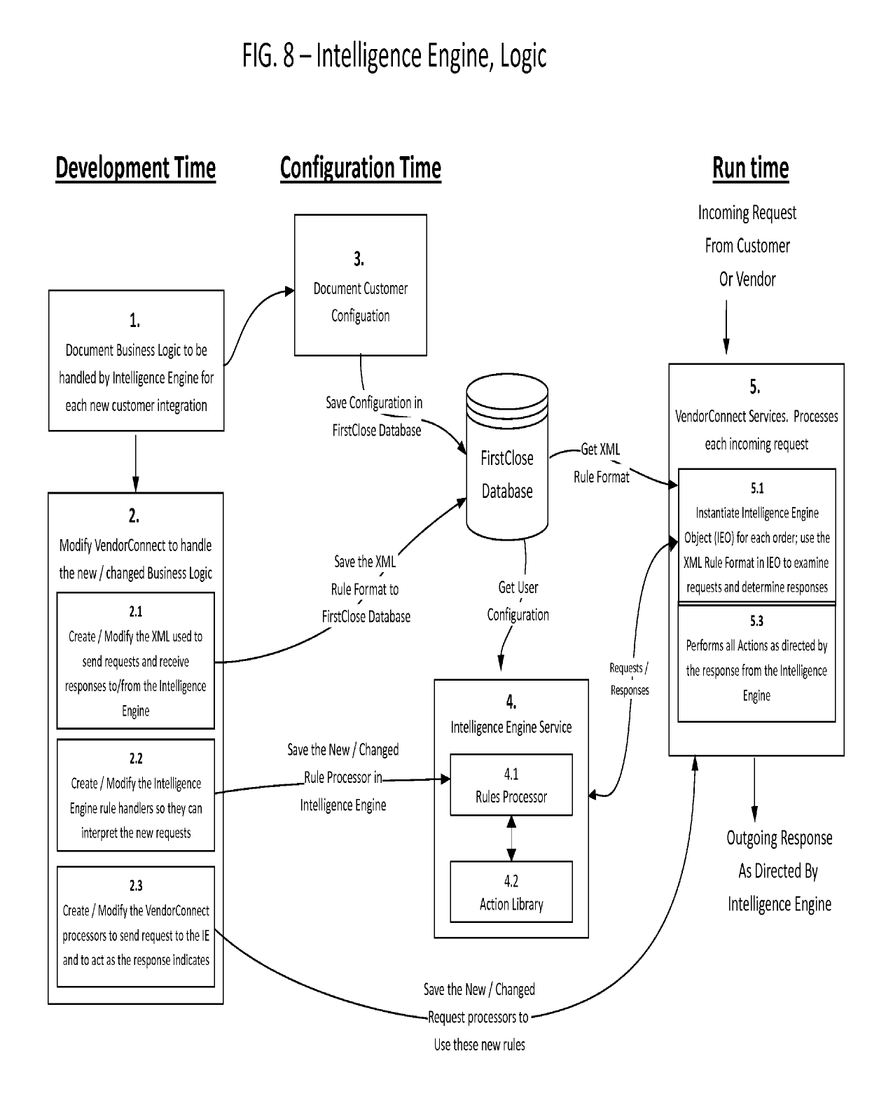

FIG. 5 is a depiction of the Intelligence Engine which drives much of the decision making in obtaining the content for and assembling the Report. FIG. 5 is a high level diagram showing how a service called the “Intelligence Engine” is used to guide the processing of the Report (See, also, FIG. 8). As FIG. 5 illustrates, the user develops a preferred profile (or configuration) for a Report, which is stored in the Database. When a “request” for a Report is received, the Intelligence Engine uses the request and the profile to order vendor information. The flowchart of FIG. 5 shows an example of how the customer request or “order” is processed until the Report is sent.

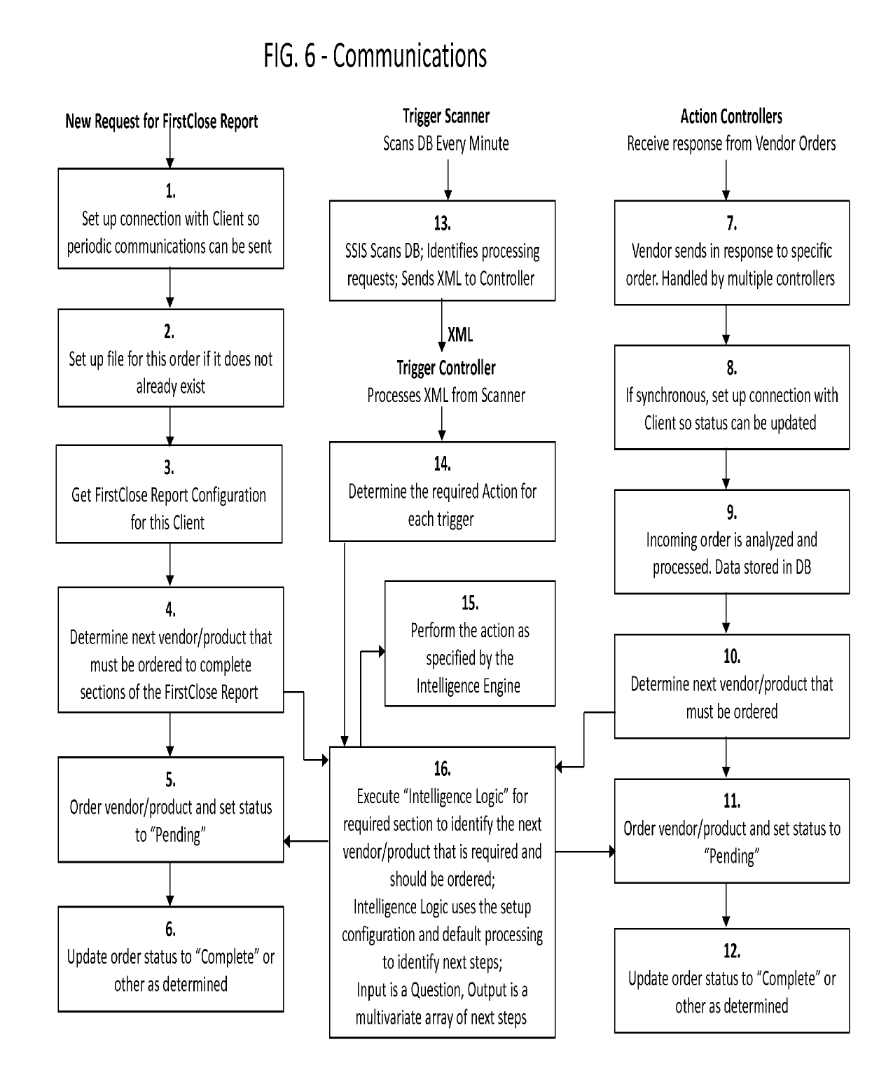

FIG. 6 illustrates the communications of the Intelligence Engine. FIG. 6 shows a high level view of the communications between the “New Request,” “Trigger Scanner,” and “Vendor Response” Processes, and the Intelligence Engine. FIG. 6 also highlights how the Intelligence Engine uses a setup configuration to customize its responses for each user creating a profile. As can be appreciated, the flow chart of FIG. 6 is somewhat busy showing the various communication pathways between software processes.

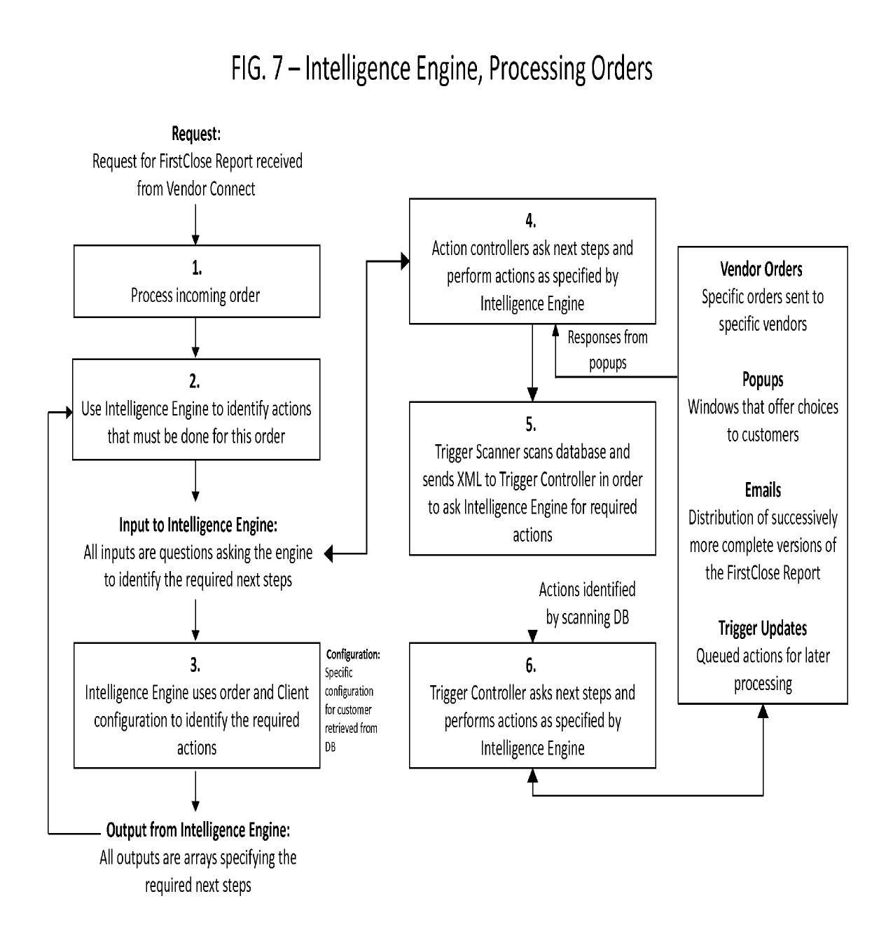

FIG. 7 describes how the Intelligence Engine processes orders or requests from a customer. Both incoming requests for the Report AND triggers coming in from the trigger processor can activate the Intelligence Engine. The Intelligence Engine is used to guide processing by identifying the next steps, such as sending orders to vendors, providing popups so the user can make choices, sending emails to inform the user of any Report updates, or adding triggers to the database to cause future actions. FIG. 7 shows some of the internal loops that can occur during order processing to initiate actions prior to Report completion.

FIG. 8 describes how the logic used in the Intelligence Engine. As shown in FIG. 8, the Intelligence Engine has different components active at Development Time, Configuration Time, and Run Time. At Development Time, the system is made to handle the incoming and outgoing XML transactions, and the handler infrastructure and action methods are developed. At Configuration Time, the system writes the rules based on the unique customer configuration and the rules and actions stored in the Intelligence Engine Service, which are then compiled and stored. At Run Time, the system reads the incoming transaction executing the code written at Development Time, while referencing the rules written and compiled at Configuration Time. As explained in more detail below, preferably an Intelligence Engine Object (IEO) is instantiated upon receipt of a customer order and based on the customer profile. At Run Time, the IEO is used to perform the required actions to generate the Report.

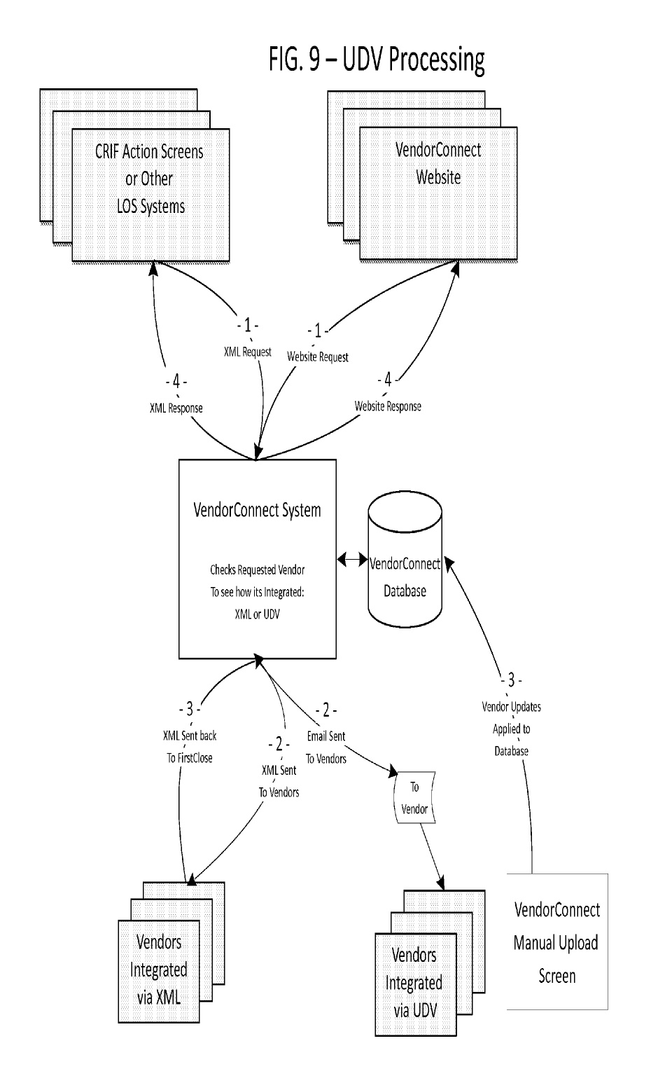

FIG. 9 is a high level description of the UDV Processing. FIG. 9 depicts how the Report uses certain unique processes to send requests to vendors via email instead of XML, and to then receive the response from the vendor via email, also instead of XML. It does this transparent to the user because both ways of communicating to the vendor still use the same XML to communicate from/to the user.

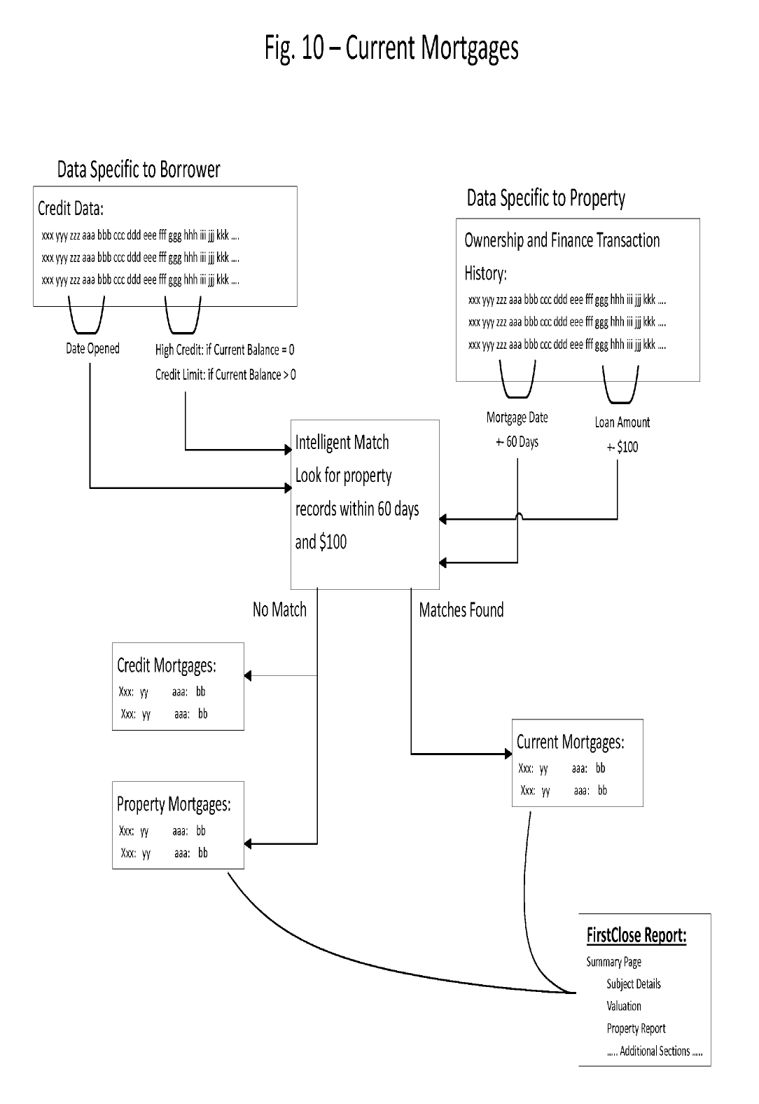

FIG. 10 shows in more detail the comparison of FIG. 3 where various mortgage records are used to identify mortgages for the borrower and the property. In FIG. 10, the Intelligence Engine matches credit data specific to the borrower with voluntary and involuntary lien transaction history specific to the property. As can be seen in the example of FIG. 10, a match is made if credit data for the borrower is within 60 days of the mortgage date. In addition, a loan amount threshold (e.g., $100) is used. The time window and threshold amount can be set by a user. The Report provides the details to the user. (This is sometimes known as “Progressive Matching” herein.)

### Intelligence Engine Operation

The preferred implementation of the Intelligence Engine (IE) works by instantiating an “Intelligence Engine Object” (IEO) at runtime, and then referencing that IEO during processing to retrieve data, make processing decisions in accordance with the user profile, and help determine the next steps. This IEO is comprised of 5 parts:

Data: Each new order creates its own runtime IEO, and as the IEO is created, it is loaded with data from the unique customer profile. This includes data such as customer name, AND also critical settings and actions that the user has chosen for his profile. For example, the customer may have chosen to automatically continue processing ONLY for those orders that have a Loan to Value (LTV) ration LESS than 70%. In this case, the IEO will have recorded an LTV limit of 70%, and that for orders less than that, to automatically continue, and for those greater, to stop processing.

Go Methods: Each IEO requires some housekeeping methods to simplify its use. For example, there is always a “Load” method that reads the profile from the database and loads the data elements into the IEO variables for use by the methods in both the IEO AND in the order object.

Decision Methods: During design time, the programmers figure out all the decisions that much be made to meet the user requirements. These decisions are encoded into the object, and are called as the order is processed during runtime. For example, one Decision Method may be a simple “CalculateLoanToValue.” As the order is processed, we need to know the LTV in order to determine what to do, so the system calls the method to calculate the value.

Also, there are more complex methods such as “IsLTVToHigh.” Instead of calling a simple procedure that just returns a calculated value, the system may call this Decision Method to look at the data, make required calculations, examine the user's profile, and determine the next step.

Action Methods: Action methods carry out the decisions of the Decision Methods. For example, in order to calculate the LTV, the system needs to know the loan amount. If this is not in the data then the system must display a popup that lets the user enter that value. So there is an Action Method to do this: “GetLoanAmount.” There may be other types of Action Methods that are used to stop processing. for example, suppose the system determines the LTV is too high—that is, that it is above the limit set by the user and recorded in his unique profile. Also according to the profile, the user has decided to stop processing if its over that set amount. So in the case when LTV is too high, the system needs a “Stop Processing” method that handles any notices or emails or cleanup needed to stop processing the order. So there is an Action Method called “StopProcessing.”

Customizable Logic: A unique aspect of the IEO is that it contains a list of methods that have been determined to be the right methods to call for this user. For example. One customer may want to send an email if LTV is too high (StopProcessingWithEmail), whereas another customer may want to just show a popup (StopProcessingWithPopup). Both of these are different kinds of “StopProcessing” methods. During setup time the system examined the customer profile and stored the exact name of the correct “StopProcessing” method into the Customizable Logic section of the IEO. So suppose a customer wants an email when processing stops. When the system decides to stop processing, it examines this logic section to find the name of the stop processing method, in this case “StopProcessingWithEmail,” and then calls that exact method.

Logical vs Physical Objects: The above schematic and explanation simplifies the content and operation of the IEO for the sake of introduction and clarity. A detailed examination of the code will show that the description more accurately depicts a “Logical” view of the IEO. In actual fact, the physical object has only a subset of all the codes and methods, and references the Intelligence Engine Service (IES) for those that are not actually in the object itself. The IES is a normal web service that returns items as requested. Since the actual location of the data and method is not important for understanding how the system works and indeed, can be changed as performance constraints arise, the remainder of the document will continue to reference the IEO as if it contained all the data and methods.

### Intelligence Engine Object Initialization at Setup Time

When a user orders a new Report, the first thing that happens is that the unique profile for that order is loaded into the IEO. This happens by calling the below Load method of the IEO: FIG. 11A

Based on this profile all the Report elements will be loaded into the IEO and become available for the processing of the order. FIG. 11B is an example of referencing the IEO for profile data. It is a picture of a real IEO listing the variables that are stored in the object. Notice for example, one is called “ConfiglD.” The value beside the item is “16.” FIG. 11B shows that the variable “ConfigID” have a value of 16, and that value can be referenced and used during the processing of the order.

### Intelligence Engine Object Usage at Processing Time

When the user clicks the submit button on the website to start processing the Report order, and after the IEO is instantiated and initialized with the data from the user profile, the object is ready to help direct the processing of the order. The graphic of FIG. 11C is an expansion of an element called “Configuration” that can also be seen in the graphic of FIG. 11B. This element value is the specific profile data for that order and for that customer:

### Intelligence Engine Sending the Action Methods to Order Service

In addition to retrieving data, the IEO can examine the profile and send the action methods back to the order service. The graphics (FIG. 12A) show how the IEO returns different action methods depending on different profiles. The first graphic of FIG. 12A shows that a profile can specifies 2 processing logic paths that can be set during profile, in this case, they are both called “BumpLogic.” BumpLogic(0) and BumpLogic (1) are the 2 action methods provided for the LTV valuation example above. BumpLogic(0) shows the decision is “ShowValuationStopPopUp,” whereas BumpLogic(2) shows the decision is “ShowCalculateLTVPopup.”

When the user profile was set up, there were multiple “BumpLogic” scenarios that were made available to the user. For example, In the below BumpLogic(0), the user could have chosen the logic that bypassed the popup and got the loan amount from the database. But instead, they chose to have a popup.

During runtime, when the profile is loaded, and executes the logic chosen by the user. In this example, the order processing will call the first one to run the “ShowValuationStopPopUp” method, and then it will call the second one. See FIG. 12A.

### Intelligence Engine Decision Methods Called by Order Service

The IEO provides a framework for Decision Methods in addition to the Action Methods described above. In the example of FIG. 12B, the order processing needs to determine if the LTV is too high, and if so, it then needs to determine what to do. As described above, this decision logic depends on the user preference as stored in the user profile. For example, the order system calls an IEO Decision Method “CalculateLTV_Actual.” When called, the method checks the LTV which has already been calculated and determines if it's over the limit specified in the user profile. If it is, the IEO returns the appropriate action to the order object, which then shows the appropriate popups indicating the order does not meet the minimum LTV amounts specified by the customer or process the order. See, FIG. 12B

### Intelligence Engine Object Customizable Logic

One last feature of the IEO is the use of customizable logic. Heretofore we have referenced names of methods as if all customers wanted the same kind of processing for each method, when in fact, there can be significant differences.

There are two alternative logic rules that can be used during order processing as illustrated in FIGS. 13A and 13B. The choice of which logic rule to use may vary from user to user based on the particular needs of that user. During profile time, the user chooses the logic they want to execute in a particular situation from among multiple alternatives. The profile then records their choice, and when the processing of an order needs that logic, the logic chosen by the customer is executed by the system and the decision, or “return value” is handled accordingly. See, FIGS. 13A, 13B

### Customizable Logic in IntelligenceEngineObject

### Illustrated in FIG. 13C.

The system will use the logic of FIG. 13C and send back a “return value” from the decision method. The order service will examine the returned value and then complete the appropriate actions. See, FIG. 14 and FIG. 15.

The IEO is richly textured object that is made up of multiple parts: data, methods, and customizable logic with variable rules. We can see that this multi-faceted object is endowed with complex capabilities and ends up becoming unique in a significant way: It can think. This TEO object can store date and methods like normal object, AND it can also consider the unique needs of each user and take these needs into account when rendering a decision. And since these decisions change the processing of the system, we end up with a system that recognizes the user, understands their unique needs, decides on matters according to the way the user wishes to decide, and does this all in the few seconds it takes to order the Report.

It will be appreciated to those skilled in the art having the benefit of this disclosure that this invention is believed to address many of the challenges, noted above, that exist in obtaining due diligence information for real estate transactions and generating a Report. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for generating a Report to a customer relating to a potential real estate transaction, comprising:
building a customer profile indicative of Report profile and saving the profile to a database;
building an XML rule format associated with said customer profile and saving the XML rule format to a database;
receiving a request for a Report from a customer;
upon receiving the request, accessing the associated XML rules format from the database and requesting an Intelligence Engine to process the request, including using the customer profile and request to perform actions to obtain information from a number of information vendors;
generating a customer file associated with the request in a database and receiving information from vendors in said customer file;
populating the customer file with the information returned from the separate information vendors; and
assembling a Report using the information populated in the customer file in the database based at least in part on said customer profile.

2. The method of claim 1, wherein the Intelligence Engine builds an Intelligence Engine Object (IEO) using the customer profile and request.

3. The method of claim 2, wherein the IEO is executed at runtime to obtain information from vendors.

4. The method of claim 1, wherein the Intelligence Engine uses domain expertise coded into rules processing and actions as part of the profile.

5. The method of claim 1, wherein the Intelligence Engine uses credit data specific to a borrower and compares the credit data with data specific to the real estate.

6. The method of claim 5, wherein the comparison is made if the credit data is within a certain time relative to any mortgage on the real estate and the credit amount exceeds a threshold set by the customer.

7. A method of configuring and operating an Intelligence Engine to perform due diligence for a real estate transaction, comprising:
accessing a customer profile;
creating an XML rule format based on said customer profile;
saving the XML rule format to a database;
operating an Intelligence Engine having rule processors created based on said customer profile and having an actions library based on said customer profile;
receiving a customer order;
using said customer order to access said XML rule format from said database and generating a request to said Intelligence Engine; and
running said Intelligence Engine after said request to identify the desired actions, including generating information requests sent to multiple information vendors.

8. The method of claim 7, including receiving vendor information and iteratively determining if all information requests have been received.

9. The method of claim 7, including assembling information received from vendors based on said customer profile.

10. The method of claim 7, the customer profile being input via customer web forms and saved to said database.

11. The method of claim 7, the customer order being received via a web interface.

12. The method of claim 7, the customer order being received via a text message which is parsed into XML to generate said request to said Intelligence Engine.

13. The method of claim 7, wherein the Intelligence Engine builds an Intelligence Engine Object (IEO) using the customer profile and request.

14. The method of claim 7, wherein the real estate transaction involves a borrower and a real estate property, including the steps of:
receiving vendor information related to the credit data of the borrower and mortgage data specific to the property;
comparing the credit data of the borrower with the mortgage data; and
including the comparison in a Report to the customer.

15. A method for creating and using an Intelligence Engine for use in real estate transaction due diligence, comprising:
inputting a customer profile into a database, including customer preferences, customer information, preferred data sources and report configuration preferences;
receiving a customer request for a real estate transaction; and
instantiating an Intelligence Engine Object (IEO) based on said customer profile and customer request, which during development time sends requests to said preferred data sources and stores information received from said preferred data sources in a database, and during run time the IEO accesses said received data and generates a report using said received data stored in the database and using said report configuration preference.
